(19) United States
(12) Patent Application Publication
(10) Pub. No.: US 2019/0362276 A1
(43) Pub. Date: Nov. 28, 2019

(54) SYSTEM AND METHOD FOR MANAGING RESOURCES

(71) Applicants: SINGAPORE UNIVERSITY OF TECHNOLOGY AND DESIGN, Singapore (SG); POWER AUTOMATION PTE LTD, Singapore (SG)

(72) Inventors: Chau YUEN, Singapore (SG); Wayes TUSHAR, Singapore (SG); Wen-Tai LI, Singapore (SG); Kristin Wood, Singapore (SG); Gim Kerk SEE, Singapore (SG)

(73) Assignees: SINGAPORE UNIVERSITY OF TECHNOLOGY AND DESIGN, Singapore (SG); POWER AUTOMATION PTE LTD, Singapore (SG)

(21) Appl. No.: 16/484,405

(22) PCT Filed: Feb. 8, 2018
(86) PCT No.: PCT/SG2018/050056

§ 371 Date: Aug. 7, 2019

(30) Foreign Application Priority Data
Feb. 8, 2017 (SG) 10201701008X

(51) Int. Cl. G06Q 10/06; G06Q 30/08; G06Q 50/06

(52) U.S. Cl. CPC G06Q 10/0631; G06Q 50/06; G06Q 30/08

(57) ABSTRACT

Embodiments of the present invention provide users with a system and method for managing resources. The method and system allow end users to participate in the trading of resources which enables lowering of costs for the end users. Furthermore, the method and system also enable utilisation of resources in a manner which can optimise a load (for example, electrical) for the resource supply. It should be appreciated that the resources can relate to, for example, water, fossil fuels, energy supplies and the like.

### FIELD OF INVENTION

The present invention relates to a system and method for managing resources.

### BACKGROUND

Many resources which are currently used on Earth are finite, and indiscriminate wastage of the resources is discouraged to ensure the sustainability of the resources. The resources can relate to, for example, water, fossil fuels, energy supplies and the like.

Currently, there are resource management methods and systems which rely on analysis of resource usage to control usage and/or minimise wastage of the resource. Known methods and systems rely on, for example, convex optimization, dynamic programming, stochastic optimization, robust programming, particle swarm optimization, game theory approaches, machine learning techniques, auctions and the like. The resource management methods and systems typically are used by end users to minimise their resource usage costs, but do not provide the end users of all kinds with a way to participate in trading with their resources. Usually, trading of resources is only carried out by entities that own/use large quantities of resources (macro-users), and not micro-users.

It is evident that trading of resources is advantageous as the end users can benefit from lower costs of using resources.

### SUMMARY

In a first aspect, there is provided a system for managing resources, the system including at least one data processor configured to:
transmit, from an agent server, an offer signal;
receive, at an end user device, the offer signal;
determine, at the end user device, a current resource usage level, and an inconvenience rating;
determine, at the end user device, if resource trading should be initiated;
provide, at the end user device, an indication that resource trading is proceeding;
control, at the end user device, usage of the resource;
determine, at the end user device, if resource trading should cease;
transmit, from the end user device, a completion signal; and
receive, at the agent server, the completion signal.

In a second aspect, there is provided a data processor implemented method for managing resources, the method including:
transmitting, from an agent server, an offer signal;
receiving, at an end user device, the offer signal;
determining, at the end user device, a current resource usage level, and an inconvenience rating;
determining, at the end user device, if resource trading should be initiated;
providing, at the end user device, an indication that resource trading is proceeding;
controlling, at the end user device, usage of the resource;
determining, at the end user device, if resource trading should cease;
transmitting, from the end user device, a completion signal; and
receiving, at the agent server, the completion signal.

In a third aspect, there is provided an end user device for managing resources, the end user device including at least one data processor configured to:
receive, from an agent server, an offer signal;
determine, a current resource usage level, and an inconvenience rating;
determine, if resource trading should be initiated;
provide, an indication that resource trading is proceeding;
control, usage of the resource;
determine, if resource trading should cease; and
transmit, to the agent server, a completion signal.

In a final aspect, there is provided a non-transitory computer readable storage medium embodying thereon a program of computer readable instructions which, when executed by one or more processors of an end user device in communication with at least one agent server, cause the end user device to perform a method for managing resources, the method embodying the steps of:
receiving, from an agent server, an offer signal;
determining, a current resource usage level, and an inconvenience rating;
determining, if resource trading should be initiated;
providing, an indication that resource trading is proceeding;
controlling, usage of the resource;
determining, if resource trading should cease; and
transmitting, to the agent server, a completion signal.

It will be appreciated that the broad forms of the invention and their respective features can be used in conjunction, interchangeably and/or independently, and reference to separate broad forms is not intended to be limiting.

### DESCRIPTION OF FIGURES

A non-limiting example of the present invention will now be described with reference to the accompanying drawings, in which:

FIG. 1 is a schematic view of an example of a system for managing resources;

FIG. 2 is a flow chart of an example of a method for managing resources;

FIG. 3 is a schematic view of an example server shown in FIG. 1;

FIG. 4 is a schematic view of an example end user apparatus shown in FIG. 1;

FIG. 5 is a schematic view of an example payment system shown in FIG. 1; and

FIG. 6 is a graph showing how a peak energy load is reduced when the system of FIG. 1 is used in a power grid context.

### DETAILED DESCRIPTION

Embodiments of the present invention provide users with a system and method for managing resources. The method and system allow end users to participate in the trading of resources which enables lowering of costs for the end users. Furthermore, the method and system also enable utilisation of resources in a manner which can optimise a load (for example, electrical) for the resource supply. It should be appreciated that the resources can relate to, for example, water, fossil fuels, energy supplies and the like.

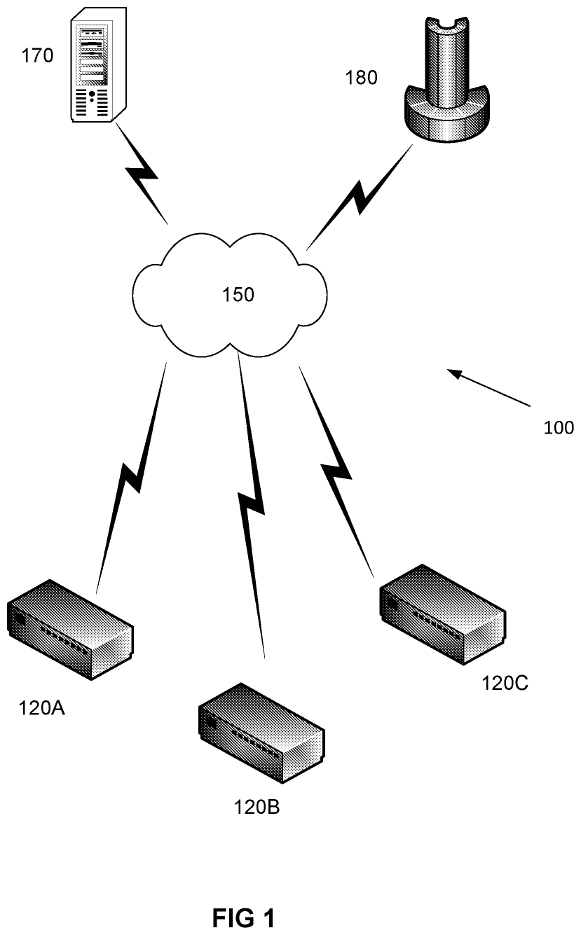

An example of a system 100 for managing resources, for example, by allowing end users to participate in trading of resources will now be described with reference to FIG. 1. The end users can be entities who use different quantities of resources, and is not restricted only to macro-users.

In this example, the system 100 includes an agent server 170, one or more end user devices 120 running a resource trading application/software, a communications network 150, and a payment system 180. It should be appreciated that the agent server 170 is typically operated by an entity facilitating the trading of resources. Typically, the end user devices 120 are installed at or around the premises of the end user entity so as to measure and record the usage of the resource by the end user entity. Each end user device 120 can be communicatively connected to at least one appliance, in a way whereby the end user device 120 is able to control the at least one appliance. The at least one appliance can be communicatively connected to the end user device 120, via the communications network 150, via a cabled connection, or via another data network. Moreover, the system 100 is typically deployed in a single country, as resource costs are inconsistent in different countries, and resource supplies are not provided across different countries. Furthermore, the end user entity can access the end user devices 120 and vary usage parameters if necessary. Further information of the end user devices 120 will be provided in subsequent paragraphs.

The communications network 150 can be of any appropriate form, such as the Internet and/or a number of local area networks (LANs). It will be appreciated that the configuration shown in FIG. 1 is for the purpose of example only, and in practice the end user devices 120, the agent server 170, and the payment system 180 can communicate via any appropriate mechanism, such as via wired or wireless connections, including, but not limited to mobile networks, private networks, such as an 802.11 network, the Internet, LANs, WANs, or the like, as well as via direct or point-to-point connections, such as Bluetooth, or the like.

End User Device 120

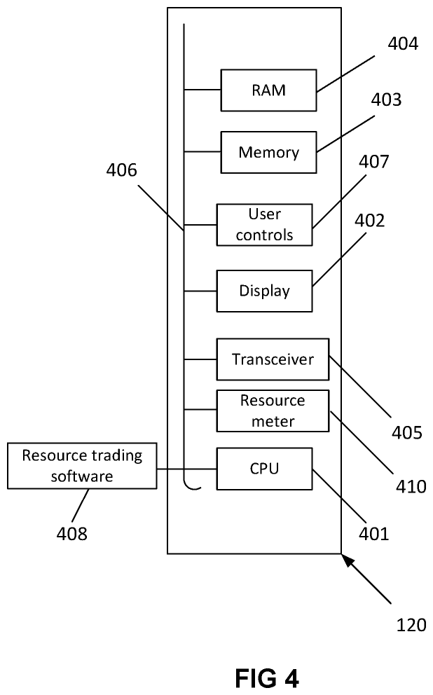

An exemplary embodiment in schematic view of the end user device 120 is shown in FIG. 4. The end user device 120 can be a device that is installed at or around premises of the end user entity so as to measure and record the usage of the resource by the end user entity, as well as facilitate the trading of the resource.

As shown, the end user device 120 includes the following components in electronic communication via a bus 406:
N processing components 401;
a display 402;
non-volatile memory 403;
random access memory (RAM) 404;
a transceiver component 405 that includes N transceivers;
user controls 407; and
a resource meter 410.

Although the components depicted in FIG. 4 represent physical components, FIG. 4 is not intended to be a hardware diagram; thus many of the components depicted in FIG. 4 may be realized by common constructs or distributed among additional physical components. Moreover, it is certainly contemplated that other existing and yet-to-be developed physical components and architectures may be utilized to implement the functional components described with reference to FIG. 4. The end user device 120 is preferably encased in a casing which is able to protect the various components, and the appearance of the casing can be aesthetically pleasing if desired.

Generally, the display 402 can configured to show content, and/or the display 402 can be used as a graphical user interface for input of instructions. The user controls 407 can be part of the graphical user interface, or physical controllers may be used as well.

The non-volatile memory 403 functions to store (e.g. persistently store) data (including information on quantitative use of the resource) and executable code received by and/or required by the end user device 120 to carry out desired tasks. In many implementations, the non-volatile memory 403 is realized by flash memory (e.g., NAND or NOR memory), but it is certainly contemplated that other memory types may be utilized as well. Executable code in the non-volatile memory 403 is typically executed by one or more of the N processing components 401 to effectuate the functional components. The random access memory 404 is typically used to provide transient storage for the end user device 120 to carry out desired tasks. A resource trading software 408 can run on the end user device 120, to facilitate processes associated with trading of a resource. Further details of the processes associated with the trading of a resource will be provided in subsequent portions of the description.

The transceiver component 405 includes N transceiver chains, which may be used for communicating with the agent server 170 via wireless networks. Each of the N transceiver chains may represent a transceiver associated with a particular communication scheme. For example, each transceiver may correspond to protocols that are specific to local area networks, cellular networks (e.g., a CDMA network, a GPRS network, a UMTS networks), and other types of communication networks.

The resource meter 410 is typically used for measuring a quantity of the resource being used by the end user, and can be configured to provide real-time resource usage readings, and/or to provide a cumulative count for the resource being used by the end user.

Agent Server 170

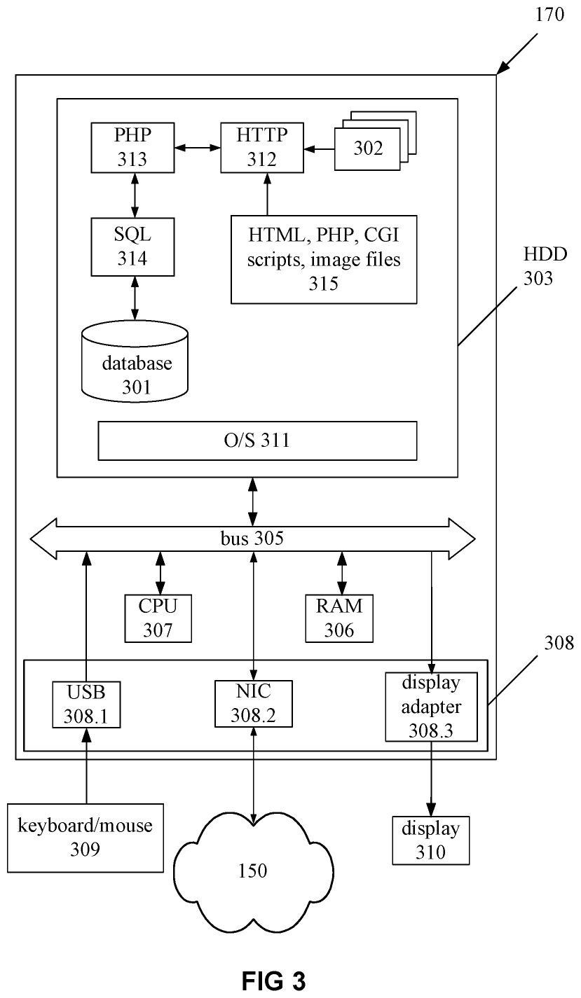

An example of the agent server 170 for use in the system 100 for managing resources is shown in FIG. 3. The agent server 170 is typically administered by an entity facilitating the trading of resources.

The agent server 170 is able to communicate with the end user device(s) 120, the payment system 180, and/or other processing devices, as required, over a communications network 150 using standard communication protocols.

The components of the agent server 170 can be configured in a variety of ways. The components can be implemented entirely by software to be executed on standard computer server hardware, which may comprise one hardware unit or different computer hardware units distributed over various locations, some of which may require the communications network 150 for communication. A number of the components or parts thereof may also be implemented by application specific integrated circuits (ASICs) or field programmable gate arrays. In the example shown in FIG. 3, the agent server 170 is a commercially available server computer system based on a 32 bit or a 64 bit Intel architecture, and the processes and/or methods executed or performed by the agent server 170 are implemented in the form of programming instructions of one or more software components or modules 302 stored on non-volatile (e.g., hard disk) computer-readable storage 303 associated with the agent server 170. At least parts of the software modules 302 could alternatively be implemented as one or more dedicated hardware components, such as application-specific integrated circuits (ASICs) and/or field programmable gate arrays (FPGAs).

The agent server 170 includes at least one or more of the following standard, commercially available, computer components, all interconnected by a bus 305:

1. random access memory (RAM) 306;

2. at least one computer processor 307, and

3. external computer interfaces 308:

a. universal serial bus (USB) interfaces 308.1 (at least one of which is connected to one or more user-interface devices, such as a keyboard, a pointing device (e.g., a mouse 309 or touchpad),

b. a network interface connector (NIC) 308.2 which connects the agent server 170 to a data communications network 150; and

c. a display adapter 308.3, which is connected to a display device 310 such as a liquid-crystal display (LCD) panel device.

The agent server 170 includes a plurality of standard software modules, including:

1. an operating system (OS) 311 (e.g., Linux or Microsoft Windows);

2. web server software 312 (e.g., Apache, available at http://www.apache.org);

3. scripting language modules 313 (e.g., personal home page, available at http://www.php.net, or Microsoft ASP); and

4. structured query language (SQL) modules 314 (e.g., MySQL, available from http://www.mysql.com), which allow data to be stored in and retrieved/accessed from an SQL database.

Together, the web server 312, scripting language 313, and SQL modules 314 provide the agent server 170 with the general ability to allow users communicatively connected to the network 150 to access the agent server 170 and in particular to provide data to and receive data from the database 301. It will be understood by those skilled in the art that the specific functionality provided by the agent server 170 to such users is provided by scripts accessible by the web server 312, including the one or more software modules 302 implementing the processes performed by the agent server 170, and also any other scripts and supporting data 315, including markup language (e.g., HTML, XML) scripts, PHP (or ASP), and/or CGI scripts, image files, style sheets, and the like.

The boundaries between the modules and components in the software modules 302 are exemplary, and alternative embodiments may merge modules or impose an alternative decomposition of functionality of modules. For example, the modules discussed herein may be decomposed into submodules to be executed as multiple computer processes, and, optionally, on multiple computers. Moreover, alternative embodiments may combine multiple instances of a particular module or submodule. Furthermore, the operations may be combined or the functionality of the operations may be distributed in additional operations in accordance with the invention. Alternatively, such actions may be embodied in the structure of circuitry that implements such functionality, such as the micro-code of a complex instruction set computer (CISC), firmware programmed into programmable or erasable/programmable devices, the configuration of a field-programmable gate array (FPGA), the design of a gate array or full-custom application-specific integrated circuit (ASIC), or the like.

Each of the steps of processes performed by the agent server 170 may be executed by a module (of software modules 302) or a portion of a module. The processes may be embodied in a non-transient machine-readable and/or computer-readable medium for configuring a computer system to execute the method. The software modules may be stored within and/or transmitted to a computer system memory to configure the computer system to perform the functions of the module.

The agent server 170 normally processes information according to a program (a list of internally stored instructions such as a particular application program and/or an operating system) and produces resultant output information via input/output (I/O) devices 308. A computer process typically includes an executing (running) program or portion of a program, current program values and state information, and the resources used by the operating system to manage the execution of the process. A parent process may spawn other, child processes to help perform the overall functionality of the parent process. Because the parent process specifically spawns the child processes to perform a portion of the overall functionality of the parent process, the functions performed by child processes (and grandchild processes, etc.) may sometimes be described as being performed by the parent process.

Payment System 180

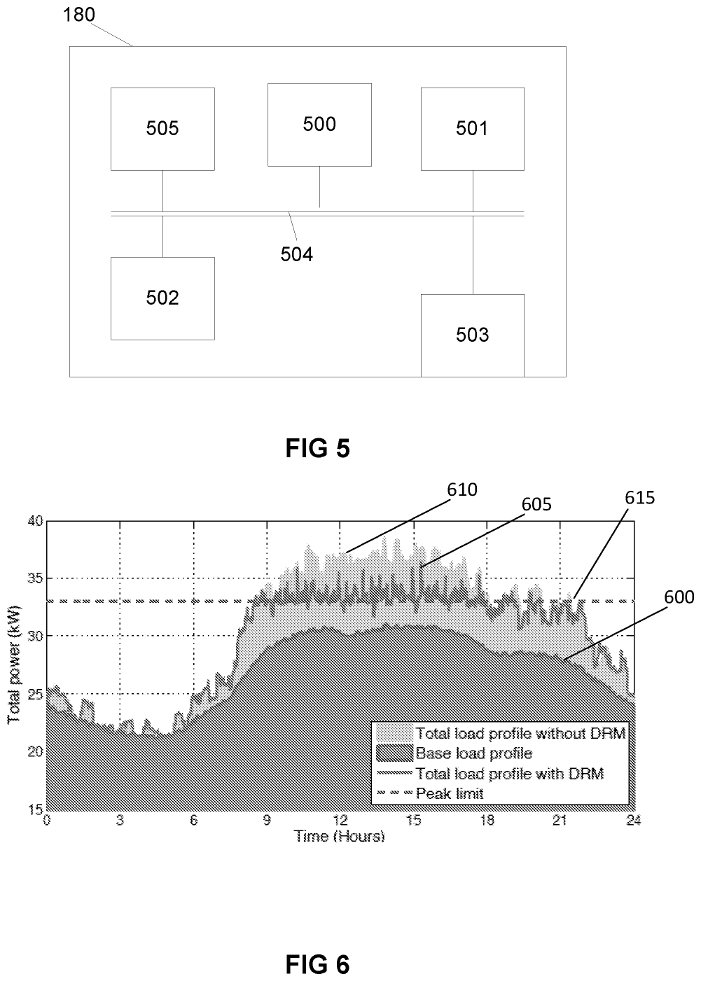

A payment system 180 for use in the system 100 is shown in FIG. 5.

In this example, the payment system 180 is a server (though in practice, the payment system 180 will comprise multiple such servers) that includes at least one microprocessor 500, a memory 501, an optional input/output device 502, such as a display, keyboard, touchscreen and the like, and an external interface 503, interconnected via a bus 504 as shown. In this example the external interface 503 can be utilised for connecting the payment server 180 to peripheral devices, such as the end user devices 120, the agent server 170, the communication networks 150, or the like. Although a single external interface 503 is shown, this is for the purpose of example only, and in practice multiple interfaces using various methods (e.g. Ethernet, serial, USB, wireless or the like) may be provided.

In use, the microprocessor 500 executes instructions in the form of applications software stored in the memory 501 to allow communication with the aforementioned peripheral devices. The applications software may include one or more software modules, and may be executed in a suitable execution environment, such as an operating system environment, or the like.

Accordingly, it will be appreciated that the payment system 180 may be formed from any suitable processing system, such as any electronic processing device, including a microprocessor, microchip processor, logic gate configuration, firmware optionally associated with implementing logic such as an FPGA (Field Programmable Gate Array), or any other electronic device, system or arrangement. Thus, in one example, the processing system is a standard processing system such as an Intel Architecture based processing system, which executes software applications stored on non-volatile (e.g., hard disk) storage, although this is not essential.

In other examples, such as described above, the payment system 180 is formed of multiple computer systems interacting, for example, via a distributed network arrangement. In particular, the payment system 180 may include or be in communication with a number of processing systems associated with each of an issuer, acquirer, card network and payment gateway, or alternatively, the payment system 180 may be administered by any one or more of these entities.

In one example, the payment system 180 ensures that the agent (for example, the entity facilitating the trading of resources) makes payment to an end user. In addition, the payment system 180 can also ensure that the agent is able to get paid by an entity or entities supplying the resource,

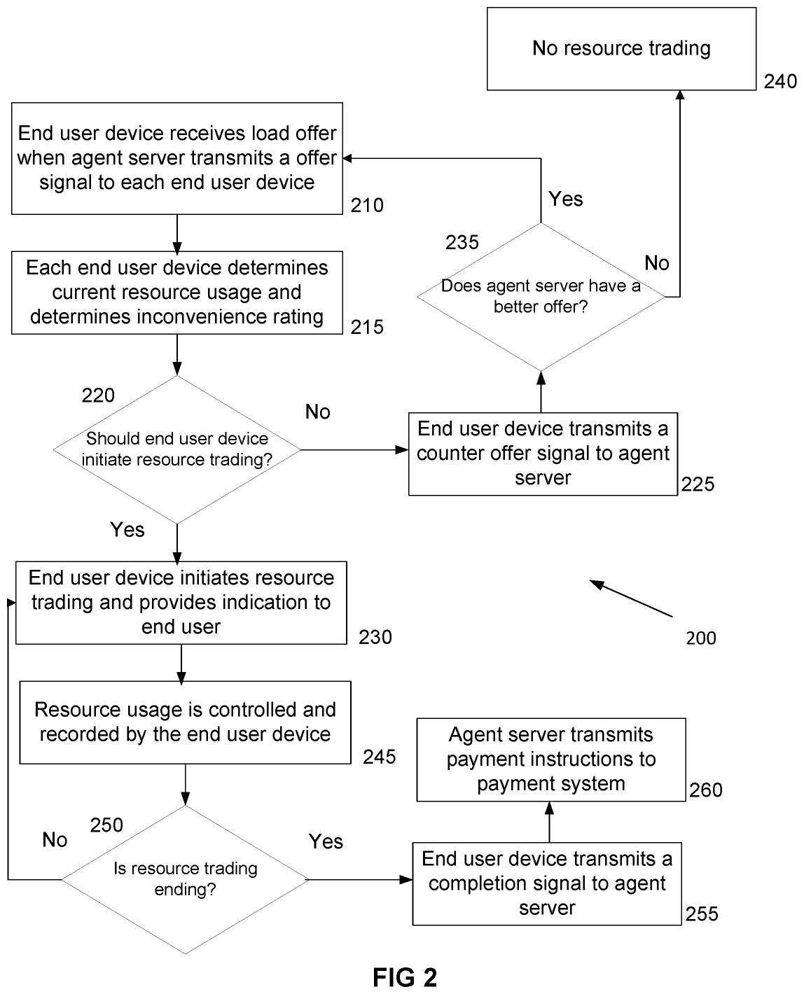

An example of a method 200 for managing resources will now be described with reference to FIG. 2. A preferred practical implementation of the method is provided in relation to energy management, and, for the sake of illustration, components employed in the method are identical or similar to the components as described in earlier paragraphs. It should be appreciated that the method can also be used to manage other resources supplied by a provider, like, for example, water, natural gas, and so forth.

At step 210, an end user device receives an offer signal to begin resource trading. The end user device receives such offers continuously, either at regular time intervals or on an ad-hoc basis. The offer signal is transmitted from the agent server to the end user device. The offer signal typically includes data to enable resource trading, such as, for example, resource pricing, payment details, duration of resource trading, thresholds for energy reduction, starting time, control instructions for the end user device and devices connected to the end user device, a signal identifier and so forth.

Subsequently, at step 215, each end user device determines real-time resource usage and determines an inconvenience rating according to a pre-defined inconvenience index. The real-time resource usage is typically measured using a resource meter of the end user device. The inconvenience index can be defined in a manner which is dependent on an end user. For example, the end user can define an index of a number of hours before a hot shower can be taken, whereby ten minutes is a low inconvenience value while five hours is a high inconvenience value. In another example, the end user can define an index of a number of hours before a television can be switched on, whereby ten minutes is a low inconvenience value while five hours is a high inconvenience value. The inconvenience can be determined based on, for example, a starting time of interruption, a total number of interruptions, total duration of interruptions, the total amount of load to be interrupted and end users' preferences. The determination of inconvenience is further motivated by the type of control mechanism will be used, the resulting variation of temperature (for example, air-conditioning systems) due to resource trading and the resulting shift in time and the difference between the original and the offered starting time of each scheduled task. The inconvenience can be compared with a pre-defined threshold, which can be derived from historically available data on incentives and/or related prior inconveniences.

The end user device then determines if resource trading should be initiated at step 220. For example, an assessment is carried out of the following:

a) Is proposed resource usage less than an end user defined upper limit?

b) Is inconvenience level lower than an end user defined upper limit?

c) Is an incentive greater than an end user defined upper limit?

d) Does inconvenience occur within a user defined period?

If an outcome for every question (a) to (d) is positive, at step 230, the end user device initiates resource trading and provides an indication to the end user, for example, showing an indication on the display of the end user device.

If an outcome for any one of questions (a) to (c) is negative, the end user device transmits a counter offer signal to the agent server at step 225. The counter offer signal typically includes data, such as, for example, a revised (incentivised) resource pricing, a revised (incentivised) total duration, revised (incentivised) thresholds on energy reduction, revised maximum threshold, revised minimum threshold, information on real-time resource usage, information on forecasted post-trading resource use, information on total resource used during the energy trading period and so forth. The counter offer signal is typically for processing by the agent server. If, after assessment of the counter offer signal at step 235 and the agent (via the agent server) is able to provide an improved offer, the agent server then transmits another load offer to the end user device at step 210. If the assessment of the counter offer is negative, no resource trading occurs at step 240.

Subsequent to step 230, during the course of resource trading at step 245, each end user device controls the usage of the resource at a synchronized starting point (in conjunction with other end user devices) either by following control instructions in the offer signal or based on its own logic control scheme. In addition, each end user device also records usage of the resource during the resource trading process. Control of the usage of the resource by the end user device can include controlling the at least one appliance communicatively connected to the end user device.

The end user device then determines cessation of the resource trading process at step 250. Cessation of the resource trading process can occur when, for example, the duration of resource trading is reached. When the resource trading process is on-going, the end user device continually provides an indication to the end user at step 230.

Once the resource trading process ceases, the end user device then transmits a completion signal to the agent server at step 255. The completion signal typically includes information on a quantity of resource measured at the end user device.

Finally, at step 260, the agent server then transmits instructions to the payment system to ensure that appropriate end users are paid for participating in the resource trading process. It should be appreciated that the payment can be made based on a per unit of resource used, or any other method.

Referring to FIG. 6, there is shown a power vs time graph for energy usage by a plurality of end user devices. Line 600 shows a base load profile, line 610 shows a total load profile when no energy trading is taking place, line 605 shows a total load profile when energy trading is taking place, and line 615 shows a peak limit. Comparing line 610 and line 605 shows that a peak load is reduced during energy trading. This reduction of peak load is advantageous during energy trading.

It is foreseeable that the system and method can be used for applications such as, for example, energy trading for electric vehicles in grid-to-vehicle, vehicle-to-vehicle and vehicle-to-grid scenarios, energy trading for demand response management in smart home networks and building energy management systems, energy management within a microgrid and between microgrid and macrogrid, water trading, natural gas trading, and so forth. Furthermore, the resource trading aspect can be automated, and negotiation aspects can be built-into the method and system.

Throughout this specification and claims which follow, unless the context requires otherwise, the word “comprise”, and variations such as “comprises” or “comprising”, will be understood to imply the inclusion of a stated integer or group of integers or steps but not the exclusion of any other integer or group of integers. Persons skilled in the art will appreciate that numerous variations and modifications will become apparent. All such variations and modifications which become apparent to persons skilled in the art, should be considered to fall within the spirit and scope of the invention

1. A system for managing resources, the system including at least one data processor configured to:
transmit, from an agent server, an offer signal;
receive, at an end user device, the offer signal;
determine, at the end user device, a current resource usage level, and an inconvenience rating;
determine, at the end user device, if resource trading should be initiated;
provide, at the end user device, an indication that resource trading is proceeding;
control, at the end user device, usage of the resource;
determine, at the end user device, if resource trading should cease;
transmit, from the end user device, a completion signal; and
receive, at the agent server, the completion signal.

2. The system of claim 1, the system including at least one data processor configured to transmit, from the agent server, payment instructions for end users partaking in resource trading.

3. The system of claim 1, wherein the offer signal includes at least one of: resource pricing, payment details, duration of resource trading, thresholds for energy reduction, starting time, control instructions for the end user device and devices connected to the end user device, and a signal identifier

4. The system of claim 1, wherein the resource trading is initiated when a positive finding is provided in relation findings related to any combination of: an amount of resource usage, an inconvenience level and an incentive level.

5. The system of claim 1, wherein the indication is a visual indication.

6. The system of claim 1, wherein the usage of the resource includes control of at least one appliance communicatively connected with the end user device.

7. The system of claim 1, wherein the completion signal includes information on a quantity of resource measured at the end user device.

8. The system of claim 1, the system including at least one data processor configured to, if it is determined that resource trading should not be initiated, transmit, from the end user device, a counter offer signal.

9. A data processor implemented method for managing resources, the method including:
transmitting, from an agent server, an offer signal;
receiving, at an end user device, the offer signal;
determining, at the end user device, a current resource usage level, and an inconvenience rating;
determining, at the end user device, if resource trading should be initiated;
providing, at the end user device, an indication that resource trading is proceeding;
controlling, at the end user device, usage of the resource;
determining, at the end user device, if resource trading should cease;
transmitting, from the end user device, a completion signal; and
receiving, at the agent server, the completion signal.

10. The method of claim 9, further including transmitting, from the agent server, payment instructions for end users partaking in resource trading.

11. The method of claim 9, wherein the offer signal includes at least one of: resource pricing, payment details, duration of resource trading, thresholds for energy reduction, starting time, control instructions for the end user device and devices connected to the end user device, and a signal identifier

12. The method of claim 9, wherein the resource trading is initiated when a positive finding is provided in relation findings related to any combination of: an amount of resource usage, an inconvenience level and an incentive level.

13. The method of claim 9, wherein the indication is a visual indication.

14. The method of claim 9, wherein the usage of the resource includes control of at least one appliance communicatively connected with the end user device.

15. The method of claim 9, wherein the completion signal includes information on a quantity of resource measured at the end user device.

16. The method of claim 9, further including, if it is determined that resource trading should not be initiated, transmitting, from the end user device, a counter offer signal.

17. An end user device for managing resources, the end user device including at least one data processor configured to:
receive, from an agent server, an offer signal;
determine, a current resource usage level, and an inconvenience rating;
determine, if resource trading should be initiated;
provide, an indication that resource trading is proceeding;
control, usage of the resource;
determine, if resource trading should cease; and
transmit, to the agent server, a completion signal.

18. The device of claim 17, the device including at least one data processor configured to, if it is determined that resource trading should not be initiated, transmit, to the agent server, a counter offer signal.

19. A non-transitory computer readable storage medium embodying thereon a program of computer readable instructions which, when executed by one or more processors of an end user device in communication with at least one agent server, cause the end user device to perform a method for managing resources, the method embodying the steps of:
receiving, from an agent server, an offer signal;
determining, a current resource usage level, and an inconvenience rating;
determining, if resource trading should be initiated;
providing, an indication that resource trading is proceeding;
controlling, usage of the resource;
determining, if resource trading should cease; and
transmitting, to the agent server, a completion signal.

20. The storage medium of claim 19, the method further embodying the step, if it is determined that resource trading should not be initiated, transmitting, to the agent server, a counter offer signal.
